(19) United States
(12) Patent Application Publication
(10) Pub. No.: US 2012/0069208 A1
(43) Pub. Date: Mar. 22, 2012

(54) Methods, Systems , and Computer Program Products for Assuring Horizontal Image Capture

(76) Inventor: Joseph Bernard Weinman, JR., Basking Ridge, NJ (US)

(21) Appl. No.: 12/885,569

(22) Filed: Sep. 19, 2010

(51) Int. Cl. H04N 5/228

(52) U.S. Cl. 348/222.1; 348/E05.031

(57) ABSTRACT

A system comprises an accelerometer, a display, an image capture means, a controller, and an indicator capable of displaying angle from vertical or horizontal, whereby the controller uses data acquired from the accelerometer to drive the indicator.

### BACKGROUND

The present disclosure relates generally to the field of photography and video capture via cameras or mobile devices with image capture capabilities, and specifically to methods, systems, and computer program products for assuring horizontal image capture.

Today, the plummeting cost of image capture devices has made photographic, multi-image, video, and cinematographic imaging more available than ever before, whether in digital SLRs, pocket cameras, or mobile devices such as smartphones or tablets. Many functions exist such as automatic focusing, face detection, red eye removal, and the like.

However, often pictures or videos are ruined because they are taken at a slant from the horizontal, that is, with an attitude or orientation departing from level, either because the photographer is a novice, conditions did not allow stable or ideal placement of the photographer, a tripod or other means of support, or ambient conditions were otherwise unfavorable, e.g., a bright day drowning out the image on the display, making it hard to judge the exact camera angle.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments provide a system comprising an accelerometer, a display, an image capture means, a controller, an indicator capable of displaying angle from vertical or horizontal, whereby the controller uses data acquired from the accelerometer to drive the indicator.

Other embodiments provide a display that comprises the indicator.

Still other embodiments provide a system further comprising an auto-shutter mode switch, whereby one or more images are captured by the image capture means when the accelerometer indicates that the system is substantially vertical or horizontal.

Other embodiments further provide a display that comprises the indicator.

Still other embodiments provide an article of manufacture, comprising a non-transitory computer readable storage medium having computer readable program code embodied therein, the computer readable program code comprising computer readable program code configured to process attitude data from an accelerometer, computer readable program code configured to acquire graphical data from an image capture means, computer readable program code configured to generate a graphical indication of the attitude data, computer readable program code configured to superimpose the graphical indication of the attitude data on the graphical data from the image capture means and drive an integrated display.

Still other embodiments further comprise computer readable program code configured to store an auto-shutter mode switch button setting; and, computer readable program code configured to capture one or more images when the auto-shutter mode switch is set and the attitude data from the accelerometer indicates a substantially vertical or horizontal attitude.

Other embodiments provide a method of assuring proper orientation during image capture, comprising acquiring orientation data, processing that data, determining whether the orientation is level, and, indicating whether the orientation is level.

Still other embodiments further comprise determining whether a mode switch is set and the orientation is level and triggering the image capture.

Still other embodiments further comprise resetting the mode switch.

Other methods, systems, devices, appliances, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of exemplary embodiments will be more readily understood from the following detailed description of specific embodiments thereof when read in conjunction with the accompanying drawings, in which:

FIG. 1 is a block diagram that illustrates systems for assuring horizontal image capture in accordance with some embodiments;

FIG. 2 is a flowchart that illustrates methods for assuring horizontal image capture in accordance with some embodiments.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Exemplary embodiments may be embodied as methods, systems, and/or computer program products. Accordingly, exemplary embodiments may be embodied in hardware and/or in software (including firmware, resident software, micro-code, etc.). Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some embodiments described herein may provide methods, systems and computer program products for assuring horizontal image capture. An accelerometer is used to provide an indicator of the current tilt of the camera from perfectly horizontal. Such an indicator may be standalone, or may be superimposed on the image displayed for framing. The photographer may then turn the camera until a desired position is reached, and then take the picture. In some alternative embodiments, a mode switch is set so that the camera automatically takes a picture when a correct angle is achieved.

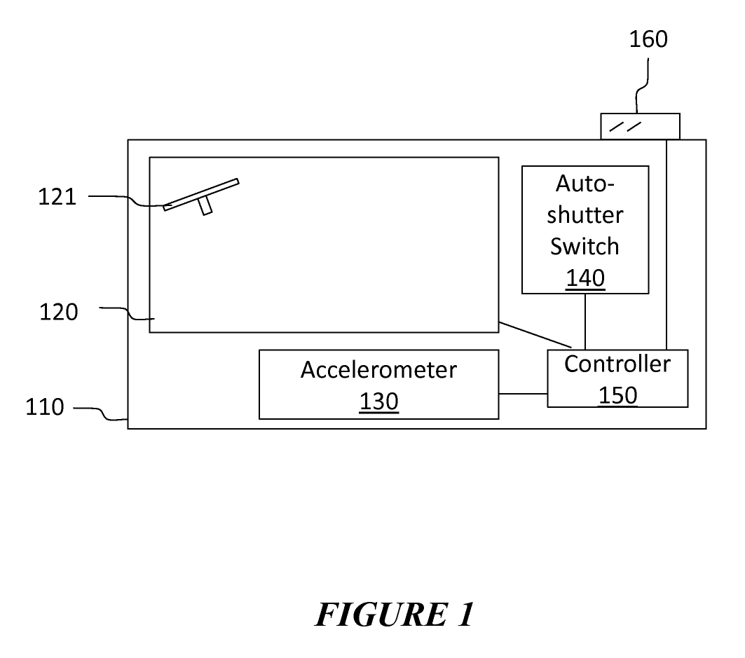

FIG. 1 is a block diagram of a system 100 for assuring horizontal image capture in accordance with some embodiments. Body 110 houses all components, and in practice may be a still camera, a video camera, a smartphone, or other device. Display 120 is normally used for displaying the “through the lens” image or such facsimile for framing, as well as displaying settings and in some embodiments permitting touch-based control. Indicator 121 shows the degree from horizontal. In this exemplary embodiment, a large horizontal line tilted to the same degree that the camera is off horizontal is illustrated, but other means of implementing the indicator are intended as well, such as a digital degree indicator, or a simulated graphic of a carpenter's level air bubble. Accelerometer 130 is used to detect the angle from vertical and thus from horizontal. Auto-shutter switch 140 may be a physical mode switch or a virtual soft-switch, but is used to control automatic picture-taking when the camera is in an acceptably horizontal position. Shutter button 160 is used to manually take a picture. Controller 150 processes raw input from accelerometer 130 to modulate indicator 121, and convolves accelerometer data with auto-shutter switch settings and/or shutter button 160 to execute a picture, multi-picture, or video capture operation. Other components (not shown) such as lens, power supply, memory for image storage, memory for stored program control, and the like may exist depending on the exact device embodiment.

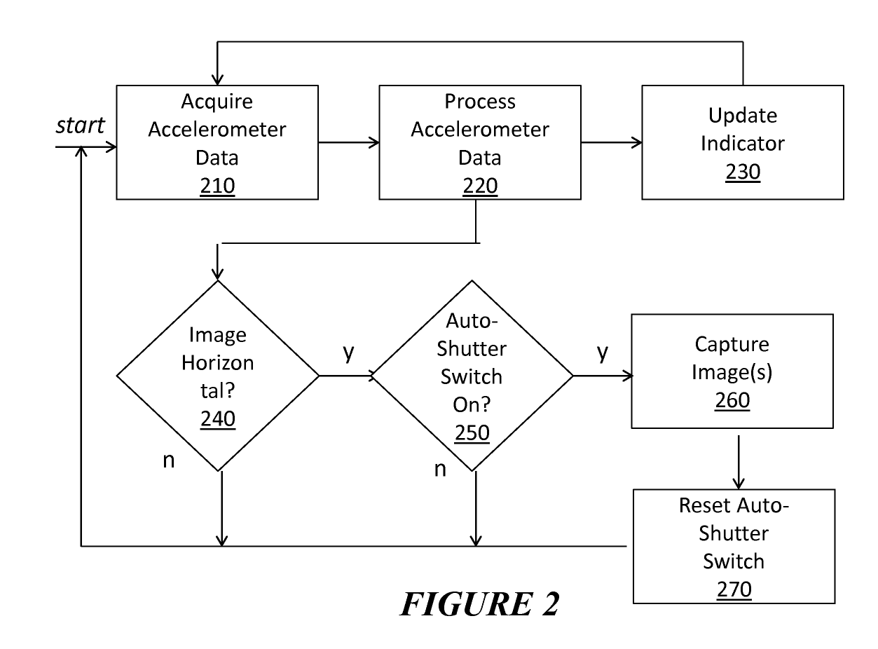

FIG. 2 illustrates a method 200 for assuring horizontal image capture in accordance with some embodiments. The method begins at block 210. In block 210, data is acquired from the accelerometer. Processing continues in block 220, where data from the accelerometer is processed to determine the angle from horizontal. If the camera is being held in a vertical position (portrait rather than landscape), then the angle from vertical is determined in this step. Processing continues at both block 230 and decision 240. In block 230, the indicator is updated to reflect the current angle.

In decision 240, it is determined if the camera is now substantially aligned with the desired horizontal position (or vertical, if the camera is within 45 degrees of being vertically oriented). If not, processing continues at block 210. If so, it is determined at decision 250 if the auto-shutter mode switch is on. If not, processing continues at block 210. If so, one or more images are captured in block 260, in accordance with other settings of the camera (not shown, e.g., picture mode, multi-frame mode, or video mode). Finally, in block 270, the auto-shutter switch is reset to the “off” position. The user may subsequently return the switch to “on” if so desired. In alternative embodiments, an auto-shutter mode switch may be used in conjunction with manual maintenance of the shutter button in a depressed position, and block 270 may be skipped.

Although FIGS. 1 and 2 illustrate exemplary methods, systems, and computer program products for assuring horizontal image capture in accordance with some embodiments, it will be understood that embodiments of the present invention are not limited to such configurations, but are intended to encompass any configuration capable of carrying out the operations described herein.

Computer program code for carrying out operations of data processing systems discussed above with respect to FIGS. 1 and 2 may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. Embodiments described herein, however, are not limited to any particular programming language. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to flowchart and/or block diagram illustrations of methods, systems, and computer program products in accordance with exemplary embodiments. These flowchart and/or block diagrams further illustrate exemplary operations for assuring horizontal image capture, in accordance with some embodiments. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Many variations and modifications can be made to the preferred embodiments without substantially departing from the principles of the present invention. All such variations and modifications are intended to be included herein within the scope of the present invention, as set forth in the following claims.

That which is claimed:

1. A system, comprising:
an accelerometer;
a display;
an image capture means;
a controller;
an indicator capable of displaying angle from vertical or horizontal;
whereby the controller uses data acquired from the accelerometer to drive the indicator.

2. The system of claim 1 where the display comprises the indicator.

3. The system of claim 1 further comprising an auto-shutter mode switch;
whereby one or more images are captured by the image capture means when the accelerometer indicates that the system is substantially vertical or horizontal.

4. The system of claim 3 where the display comprises the indicator.

5. An article of manufacture, comprising:
a non-transitory computer readable storage medium having computer readable program code embodied therein, the computer readable program code comprising:
computer readable program code configured to process attitude data from an accelerometer;
computer readable program code configured to acquire graphical data from an image capture means;
computer readable program code configured to generate a graphical indication of the attitude data;
computer readable program code configured to superimpose the graphical indication of the attitude data on the graphical data from the image capture means and drive an integrated display.

6. The article of manufacture of claim 5, further comprising computer readable program code configured to store an auto-shutter mode switch button setting; and, computer readable program code configured to capture one or more images when the auto-shutter mode switch is set and the attitude data from the accelerometer indicates a substantially vertical or horizontal attitude.

7. A method of assuring proper orientation during image capture, comprising:
acquiring orientation data;
processing that data;
determining whether the orientation is level; and, indicating whether the orientation is level.

8. The method of claim 7, further comprising:
determining whether a mode switch is set and the orientation is level; and, triggering the image capture.

9. The method of claim 8, further comprising resetting the mode switch.
